(19) United States
(12) Patent Application Publication
(10) Pub. No.: US 2013/0029530 A1
(43) Pub. Date: Jan. 31, 2013

(54) PLUG CONNECTOR

(71) Applicant: Karin Rafeld-Cech, Wildpoldsried (DE)

(72) Inventor: Karin Rafeld-Cech, Wildpoldsried (DE)

(73) Assignee: CERA HANDELSGESELLSCHAFT MBH, Ruderatshofen-Immenhofen (DE)

(21) Appl. No.: 13/638,154

(22) PCT Filed: May 25, 2011
(86) PCT No.: PCT/EP11/58550

§ 371 Date: Sep. 28, 2012

(30) Foreign Application Priority Data
Apr. 1, 2010 (DE) 10-2010-016-310.4

(51) Int. Cl. H01R 13/40

(52) U.S. Cl. 439/625

(57) ABSTRACT

A plug-in connector (1) of U-shaped or box-shaped cross section, which is designed as a straight connector, angle connector, corner connector or cross connector and is intended for hollow spacer profiles for insulating glass panes, having a base part (2) and two longitudinal side edges (3,4), which may be designed as limbs (5, 6) projecting up from the base, wherein the base part (2), together with the longitudinal side edges (3, 4), forms the body of the connector, characterized by the provision, for each plug-in portion, of elastically deformable lamellae (7) which project outwards along the longitudinal side edges (3, 4) and may be of inclined or curved configuration, wherein the inclination or curvature may run to the rear, as seen in the plug-in direction.

The invention relates to a plug connector with U-shaped or box-shaped cross-section, which is constructed as a straight, angle, corner or cross connector.

Such plug connectors are used in insulating glass construction for connecting spacer hollow sections for insulating glass panes.

Such a connector is provided with a base part and two longitudinal side edges, which can be formed as limbs projecting up from the base, wherein the base part together with the longitudinal side edges forms the body of the connector.

Plug connectors of that kind, primarily of metal or plastics material, of great diversity are known, which, however, all have the disadvantage of exhibiting only a limited tolerance compensation for tolerances in the spacer hollow section.

Above all, in these connectors the pressing pressure of the retaining means of the plug connector against the inner surfaces of the spacer hollow section in part significantly changes in dependence on the utilisation of the tolerance compensation.

It is the object of the invention to create a connector which even in the case of large tolerances of the spacer hollow section ensures an at least substantially identical pressing pressure of the retaining means and thus a consistently good retention even in the case of different spacer hollow sections. In addition, a force, which is as consistent as possible, for insertion of the plug connector into the spacer hollow section shall be maintained even in the case of spacer hollow sections at both ends of the tolerance range.

According to the invention this object is fulfilled in that outwardly projecting and resiliently deformable blades, which can be formed to be inclined or bent, are arranged at the longitudinal side edges for each direction of insertion, wherein the inclination or bending can be formed rearwardly in the direction of insertion.

As a result, on the hand very good tolerance compensation with, at the same time, very good clamping action of the plug connector in the hollow section is produced.

In that case it has proved very advantageous if the blades are formed to be tapering in direction away from the side edge.

A greater, but also selective, resilience is thus achieved. The more strongly the blades are bent, the greater the resistance thereof. The selective resilience can be very satisfactorily set and influenced by appropriate shaping.

According to the invention it is similarly very advantageous if at least individual blades can be constructed to be mutually contacting at least in part or connected together at least in part.

The resilience and resistance of the blades is thus further improved. If adjacent blades are in mutual contact from a specific deformation, these are more stable and sturdy.

A further very advantageous embodiment of the invention is also present if at least one abutment capable of limiting the length of insertion of the plug connector into a hollow section is provided, wherein the abutments can be arranged at the longitudinal side edges of the plug connector and constructed to be resilient.

As a result, a faulty excessively deep insertion is avoided and it is ensured that the two hollow sections ends to be connected can be acted on by the intended connector length. Above all, an excessively deep insertion can in the case of pre-inserted connectors lead to significant problems.

In that case it has also proved very advantageous if a resilient compensating element is provided in the region of the abutments.

Through this resilient compensating element an undesired tipping of the connector is avoided. In addition, it is ensured that the compensating element is not distorted during pushing on of the hollow section.

A further very advantageous development of the invention is also present if together with the outwardly projecting blades at least one blocking blade is provided which is capable of bearing with interlocking effect against the inner sides of the hollow sections to be connected.

This blocking blade seals off a cavity between the plug connector and the spacer hollow section, for example in the region of a butyl beads, and, for example, prevents the undesired issue of a molecular sieve or dessicant at the spacer hollow section joint location.

A very advantageous embodiment in accordance with a development of the invention is also present if at least one blocking blade is provided on the base part, preferably between the two limbs, for each direction of insertion.

The throughflow of the molecular sieve or dessicant through a U-shaped plug connector can be prevented by such a blocking blade. The dessicant cannot reach the joint location. If several such blocking blades are provided the sealing is improved and it is ensured that no dessicant is able to escape even if the plug connector is withdrawn partly from the hollow section, which can occur during transport of spacer hollow section frames, in the case of insulating glass production, solely due to the intrinsic weight and the size of such frames.

According to the invention it is also very advantageous if the outwardly protruding blades are inclined strongly against the direction of insertion, wherein the angle of inclination between connector transverse axis and blade is greater than 45°, preferably greater than 60°.

Easy pushing of the plug connector into the hollow section is ensured by such an inclined setting of the blades, but very good retention of the plug connector in the hollow section is nevertheless also achieved.

According to the invention it is, however, also extremely advantageous if the spacing between the blades is the same as or smaller than the thickness of the blades.

A very dense packing of the blades can thus be produced, which then, however, are nevertheless very flexible and adaptable.

An extremely advantageous development of the invention is also present if retaining elements are arranged on the connector base to protrude upwardly therefrom and can stand at least approximately perpendicularly on the base.

These retaining elements make it possible to provide support above all in the roof region of the spacer hollow section and thus ensure a further improved retention.

In that case it has proved very advantageous if the retaining elements are inclined against the direction of insertion, wherein the angle of inclination can be between 5 and 20°, preferably between 5 and 10°.

Through this inclination of the retaining elements a simplified insertion of the plug connector into the hollow section is made possible and at the same time retention is improved.

According to the invention it is also very advantageous if the cross-section of the retaining elements is formed to be at least approximately oval or round.

This embodiment ensures very good retentive clawing of the retaining elements against the inner side of the spacer hollow section.

It has also proved very advantageous if at least a part of the retaining elements is constructed to be chamfered in the direction of insertion.

Pushing of the plug connector into the hollow section is thereby facilitated.

A further extremely advantageous embodiment is also present when the retaining elements are formed to be tapering going out from the base.

Through such a shaping the retaining elements can be given a desired resilience, whereby these also adapt very satisfactorily to the different dimensions of the hollow section and provide compensation for tolerances. In that case, however, the pressing pressure remains almost constant over a wide range, for which reason the plug connector holds very satisfactorily in the hollow section.

According to the invention it has also proved very advantageous if the plug connector is formed to be chamfered at its ends.

Through these chamfered ends the plug connector can be pushed particularly securely and simply into the hollow sections. A mechanical insertion is also facilitated and made more secure.

The invention is explained in the following by way of an exemplifying embodiment, in which:

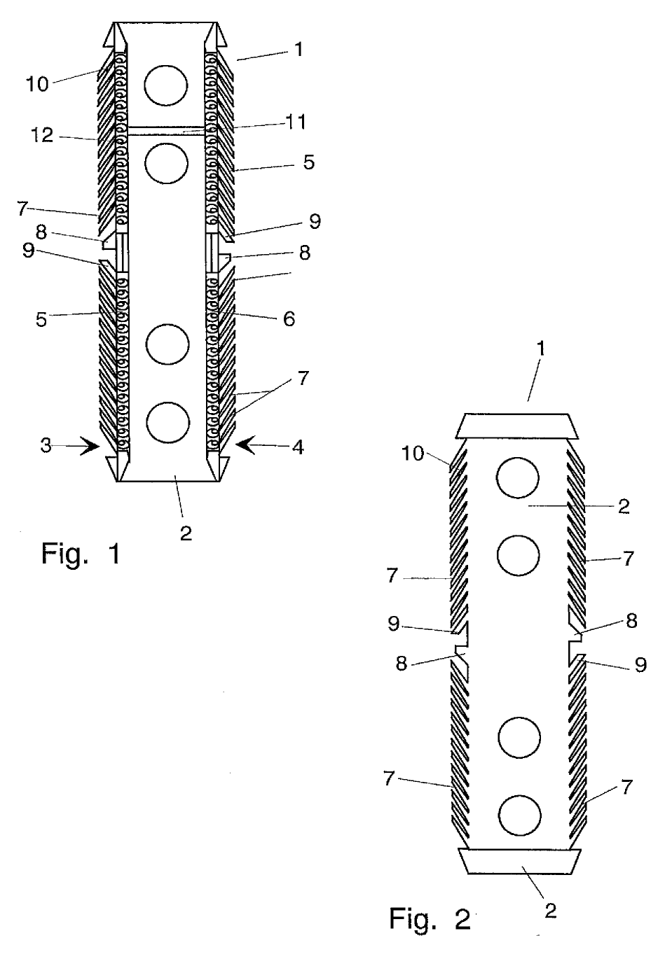

FIG. 1 shows a plan view of a plug connector according to the invention, which is constructed as a U-connector with a base surface and two longitudinal side webs arranged at the longitudinal side edges,

FIG. 2 shows a view of the base surface of the same connector and

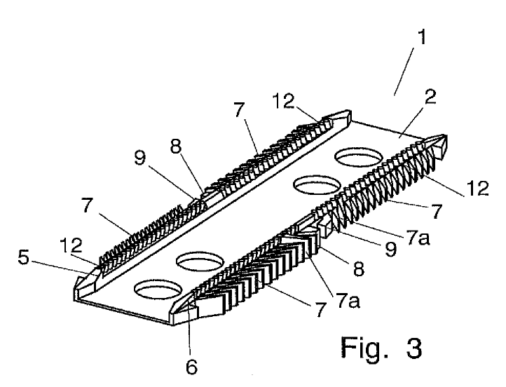

FIG. 3 shows a graphical representation of the connector.

A U-shaped plug connector with a base part 2 and two longitudinal side webs 5 and 6 connected with the longitudinal side edges 3 and 4 is denoted in FIG. 1 by 1.

Blades 7, which protrude outwardly and face rearwardly in direction of insertion and which can resiliently deform and thus capable of adapting to the respective hollow section, are arranged at the outer sides of the longitudinal side webs 5 and 6. The blades 7 wedge against the inner sides of the respective hollow section and thus prevent the plug connector from being erroneously withdrawn from the hollow section.

A respective centre abutment 8, which limits the depth of insertion of the connector 1 into the hollow sections, is similarly provided in the region of the centre of the connector 1 at the outer sides of the longitudinal side webs 5 and 6 for each direction of insertion.

A respective compensating element 9, which is provided opposite the centre abutments 8 at the other longitudinal side web 5 and 6, is associated with each of the centre abutments 8.

The compensating element 9 is formed to be elastically resilient and on the one hand ensures that the hollow sections hit against the centre abutments 8. On the other hand, compensation is provided for possible production tolerances of the hollow section. A rocking of the connector 1 in the hollow section is avoided.

The outwardly projecting blades 7 can extend over a part or the entire height of the side webs 5 and 6. In addition, the blades 7 can be formed to taper going out from the side webs 5 and 6. Through this change in thickness in the blades 7 a selective adaptation of the resilience of the blades 7 is achieved, which keeps the pressing pressure substantially the same even in the case of different sizes—which arise due to production tolerances—of the hollow sections. In that case it is also conceivable for a plug connector 1 to be usable for two section sizes adjacent to one another or also similar section contours and for adaptation to the different hollow section dimensions to be undertaken by the resilient blade 7.

The tapering of the blades 7 can in that case take place in steps or also linearly. Discontinuous tapering profiles are equally conceivable.

Moreover, it is conceivable for the blades 7 to have on at least one sub-region of the height thereof an additional support element 10 which can be formed at a blade 7 and ensures that this blade 7 and the adjacent blade 7 are, for example, capable of support against one another from a predetermined amount of bending. In that case, this support element 10 can also be shaped so that the two blades are connected together at least over a part of the length thereof.

In addition, the support element 10 can also act as a stiffening element formed directly at a blade 7 so that the blade 7 experiences a selective change in resilience.

In the illustrated example the blades 7 are inclined rearwardly against the direction of insertion of the plug connector 1 into the hollow section. Particularly good results with respect to the insertion force to be exerted and the force to be applied in order to withdraw the connector again from the hollow section were achieved with inclinations between 45 and 60°. Other angles of inclination are conceiveble.

Moreover, it is conceivable for the blades 7 to protrude at least approximately vertically from the longitudinal side webs 5 and 6 and to be able to be bent over on insertion into a hollow section.

Also conceivable is a form inclined in the direction of insertion or also a bent or swung design.

The blades 7 are formed to be resilient and can each in itself be relatively easily deformed. In order to ensure a sufficient retention of the connector in the hollow section a plurality of blades 7 is provided. These blades 7 can in that case have a thickness of less than one miliimetre. The blades 7 can also be arranged to be densely packed. The spacing between two adjacent blades 7 can be less than the thickness thereof.

In the illustrated example the blades 7 extend in height direction over only a part of the height of the hollow section.

Most hollow sections have in the region of the blades 7 a so-called butyl bead into which, at the time of assembly of an insulating glass pane, butyl is introduced, which produces adhesion between spacer hollow section and pane.

Many hollow sections are filled with a dessicant in order to ensure over a lengthy period of time that precipitations of moisture do not form in the insulating glass panes.

This dessicant is not to reach up to the joint edge of the hollow section ends to be connected, since there is the risk there that the dessicant issues into the pane interior space and forms contaminations there, which are not desired.

In order to avoid the dessicant being able to reach this joint location individual blades 7 can be constructed as blocking blades 7a, which are constructed to be elevated by comparison with the remaining blades 7 and have a contour matched to the inner contour of the hollow section. The blocking blades 7a can also be provided additionally to the blades 7. In order to ensure good sealing at least one blocking blade 7a is provided for each side web and for each direction of insertion.

In addition, transversely extending blocking blades 11 can be provided between the side webs 5 and 6. Running of dessicant through the plug connector 1 is prevented by these blocking blades 11. Thus, in the centre region as well it is no longer possible for dessicant to reach the joint location of the hollow section ends.

It has in that case proved very practical if at least two blocking blades 11 are provided for each direction of insertion of the plug connector, since then an undesired issue of dessicant is prevented even in the case of an erroneous, slight withdrawal of the plug connector 1 when handling already finished spacer frames.

This undesired slight withdrawal of the plug connector 1 often occurs in the case of plug connectors 1 constructed as corner or angle connectors.

The side webs 5 and 6 carry, on the side thereof remote from the base surface 2, retaining devices 12 which are oriented at least approximately vertically with respect to the base surface.

These retaining devices 12 have a round, oval or also cornered cross-section and are constructed as discrete elevations. The retaining devices 12 can be inclined rearwardly slightly against the direction of insertion, wherein angles of inclination through 10° have proved very advantageous.

it is also conceivable for the retaining devices 12 to be at least slightly chamfered in the direction of insertion.

The retaining devices 12 are similarly of selectively resilient construction and thus capable of adaptation to different hollow section dimensions. In that case, through the shape of the retaining devices 12, the dimensions thereof and the number thereof the force which has to be deployed in order to be able to insert the plug connector 1 into the respective hollow section can on the one hand be set. On the other hand, however, the retention force of the plug connector 1 in the hollow section is also thereby controlled.

A very good adaptation to different hollow section dimensions and different hollow section shapes is ensured by the resilient design of the retaining devices 12. Compensation is provided for tolerances without the retaining force of the plug connector being negatively influenced.

An at least approximately constant retaining force is always produced over a wide tolerance range.

In addition, the pressing force of the retaining devices 12 remains at least approximately constant over this entire range.

As also in the case of the blades 7, the retaining devices 12 can be formed to taper in linear or stepped shape. Equally, discrete stiffening elements are possible.

The ends of the plug connector 1 can be formed to be chamfered in order to facilitate insertion into the hollow section ends. A machine pre-plugging or also insertion is thus assisted.

A universally usable plug connector is created, which is usable as a straight, angle, cross or corner connector, through the co-operation of all aforesaid features. The possibilities of use are dependent exclusively on the combination of the insertion limbs.

Intermediate members between the two insertion limbs are conceivable, which, for example, can form a corner or an angle and be adapted to the cross-section of the respective hollow section.

The plug connector according to the invention can be used in all kinds of hollow sections. Use in aluminium, steel, stainless steel and also plastics material sections is conceivable.

Plug connectors 1 according to the invention can be used even in the case of very soft or brittle spacer sections, which are frequently used particularly in warm-edge applications.

The plug connectors 1 can be made of plastics material, fibre-reinforced synthetic material, aluminium, metal or steel. Other materials are conceivable.

The use of the plug connectors 1 is conceivable in all formats of insulating glass panes. The retaining force is sufficient even for shop-window panes with large dimensions. The spacer hollow section ends are securely held even in the case of production of such panes often of several metres size.

1. Plug connector with U-shaped or box-shaped cross-section, which is constructed as a straight, angle, corner or cross connector, for spacer hollow sections for insulating glass panes, with a base part and two longitudinal side edges, which can be constructed as limbs projecting from the base, wherein the base part together with the longitudinal side edges form the body of the connector, wherein outwardly projecting, resiliently deformable blades for each plug-in section are arranged at the longitudinal side edges and can be formed to be inclined or bent, wherein the inclination or bending can be formed rearwardly in direction of insertion, and wherein retaining elements, which can stand at least approximately perpendicularly on the base, protrude upwardly from the base part.

2. Plug connector according to claim 1, wherein the blades are formed so as to narrow in direction away from the side edge.

3. Plug connector according to claim 1, wherein at least individual blades can be formed to be mutually contacting at least in part or to be connected together at least in part.

4. Plug connector according to claim 1, wherein at least one abutment capable of limiting the insertion length of the plug connector into a hollow section is provided, wherein the abutments can be arranged at the longitudinal side edges of the plug connector and constructed to be resilient.

5. Plug connector according to claim 1, wherein a resilient compensating element is provided in the region of the abutments.

6. Plug connector according to claim 1, wherein together with the outwardly projecting blades at least one blocking blade able to be applied with interlocking action at the inner sides of the hollow sections to be connected is provided.

7. Plug connector according to claim 1, wherein at least one blocking blade is provided on the base part, preferably between the two limbs, for each direction of insertion.

8. Plug connector according to claim 1, wherein the outwardly projecting blades are inclined strongly against the direction of insertion, wherein the angle of inclination between connector transverse axis and blade is greater than 45°, preferably greater than 60°.

9. Plug connector according to claim 1, wherein the spacing between the blades is equal to or smaller than the thickness of the blades.

10. Plug connector according to claim 1, wherein retaining elements are integrated in the side webs.

11. Plug connector according to claim 10, wherein the retaining elements are inclined against the direction of insertion, wherein the angle of inclination can be between 5 and 20°, preferably between 5 and 10°.

12. Plug connector according to claim 1, wherein the cross-section of the retaining elements is formed to be at least approximately oval or round.

13. Plug connector according to claim 1, wherein at least a part of the retaining elements is formed to be chamfered in the direction of insertion.

14. Plug connector according to claim 1, wherein the retaining elements are formed to narrow going out from the base.

15. Plug connector according to claim 1, wherein the plug connector is formed to be chamfered at its ends.
